(19) United States
(12) Patent Application Publication
(10) Pub. No.: US 2006/0287893 A1
(43) Pub. Date: Dec. 21, 2006

(54) Tax factored method of purchasing life settlement policies

(76) Inventors: Sanford B. Weiss, Los Angeles, CA (US); Bruce Rosenfeld, Beverly Hills, CA (US); John Fischer, Berwyn, PA (US)

Correspondence Address: STETINA BRUNDA GARRED & BRUCKER, 75 ENTERPRISE, SUITE 250, ALISO VIEJO, CA, 92656, US

(21) Appl. No.: 11/155,443

(22) Filed: Jun. 17, 2005

(51) Int. Cl. G06Q 40/00

(52) U.S. Cl. 705/4; 705/35

(57) ABSTRACT

A life settlement method is provided for fractionalizing a life insurance policy in response to economic circumstances of an insured having a life expectancy. The method may include the steps of determining a settlement payout goal in response to the economic circumstances of the insured; determining a policy market value of the life insurance policy in response to the life expectancy of the insured; calculating a settlement percentage in response to the settlement payout goal and the policy market value, the settlement percentage being representative of a percentage of the life insurance policy being assignable by the insured; and calculating a settlement payout in response to the settlement percentage, the settlement payout being payable to the insured in exchange for assignment of the settlement percentage.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND OF THE INVENTION

The present invention is directed to a method administering a life settlement insurance program. More specifically, the present invention is directed to a methodology for fractionalizing a life insurance policy in response to economic circumstances of an insured having a life expectancy.

Life settlement programs have developed in recent years that allow an individual having a life insurance policy to receive a settlement payment in return for the assignment of the life insurance policy to another entity. For example, an insured may become ill and need funds to pay for long term health care to allow him to remain his remaining days in comfort and dignity. In such cases an insured might prefer to utilize the policy for his own benefit through a life settlement, rather than transfer those proceeds to others after his death as beneficiaries of the insurance policy. Similarly, an insured may desire to transfer a settlement payment derived from the insurance policy to beneficiaries for his use prior to his death, e.g., to help beneficiaries purchase a home or start a business. In such cases the present value of the settlement payment may be more useful than the future value of the insurance proceeds.

In administering a life settlement program, an insured may typically be required to assign his policy to a contracting entity. As part of the program, the insured may be required to provide certain personal and medical data used to calculate a life expectancy of the insured. Using the life expectancy and the policy value, the program may offer a settlement payment to the insured for assignment of the policy to the contracting entity. Alternatively, the insured may be able to obtain a policy cash-out payment from the insurance company if the insured agrees to surrender his life insurance policy to the insurance company. This surrender extinguishes any claims that the insured may have against the insurance company. However, the policy cash-out payment is typically less than the settlement payment available to the insured through the life settlement program. For example, a life expectancy of three (3) years may allow an insured to receive a higher settlement payment than if the insured is expected to live for ten (10) years. In either of these situations, the policy cash-out payment may be less than the available settlement payment. Once the insured accepts the settlement payment and assigns the policy to the contracting entity, the contracting entity is typically responsible to maintain the life insurance policies through the regular payment of premiums and other service fees. Typically there are numerous expenses associated with the life settlement program in addition to the one time proceeds payout to the insured.

As a result of the traditional structure of life settlement programs, the insured must assign the entirety of his policy to the contracting entity. In return, the insured receives a one-time settlement payment. For example, if the insured seeks to assign a life insurance policy with a large face amount (particularly those of $5 million or more), the insured will likely receive a large settlement payout and therefore may be forced to pay exorbitant taxes on the settlement payout. Typically, life settlement programs provide little flexibility to an insured. Such large, one-time payments may subject the insured to various taxes and other disadvantages.

Thus there exists a need in the art to provide greater flexibility to an insured in assigning his life insurance policy to a contracting entity. There is a need to tailor an existing life insurance policy to provide for the current and future needs of the insured. Additionally, there exists a need to provide the insured with the ability to tailor the life settlement process to suit the insured's economic circumstances.

### BRIEF SUMMARY OF THE INVENTION

A life settlement method is provided for fractionalizing a life insurance policy in response to economic circumstances of an insured having a life expectancy, the method comprising determining a settlement payout goal in response to the economic circumstances of the insured; determining a policy market value of the life insurance policy in response to the life expectancy of the insured; calculating a settlement percentage in response to the settlement payout goal and the policy market value, the settlement percentage being representative of a percentage of the life insurance policy; and calculating a settlement payout in response to the settlement percentage, the settlement payout being payable to the insured in exchange for assignment of the settlement percentage, or non-existent which may occur for a variety of reasons.

Fractionalization of the life insurance policy may require that the life insurance policy be divided into portions of desired sizes. These portions may then be exchanges for proportional settlement payouts corresponding to the exchanged portion. Through fractionalization of the life insurance policy, the insured may regulate the sale of his insurance policy and treat the life insurance policy as a divisible asset. Thus the insured may assign only as much of the life insurance policy as the insured desires.

The economic circumstances may include tax requirements. The tax requirements may correspond to an estate tax shelter of the insured. The tax requirements may also correspond to income tax requirements of the insured. The settlement payout may be less than or equal to the settlement payout goal.

The insured may assign the settlement percentage to a contracting entity in exchange for the settlement payout. The life insurance policy may require payment of an insurance premium, the insurance premium being divisible into a settlement premium and a remainder premium, the settlement premium being representative of the proportion of the insurance premium corresponding to the settlement percentage, the remainder premium being representative of the proportion of the insurance premium corresponding to the percentage of the life insurance policy not assigned by the insured to the contracting entity.

The method may further include the step of calculating a reacquisition cost in response to the settlement percentage and the policy market value, the reacquisition cost being representative of an amount payable by the insured to reacquire the settlement percentage assignable by the insured.

A life settlement policy acquisition method for fractionalizing an entire life insurance policy in response to economic circumstances of an insured having a life expectancy, the method comprising determining periodic settlement payout goals in response to the economic circumstances of the insured; determining periodic policy market values of the life insurance policy in response to the life expectancy of the insured; calculating periodic settlement percentages in response to the periodic settlement payout goals and the periodic policy market values, the periodic settlement percentage being representative of a percentage of the life insurance policy; and calculating periodic settlement payouts in response to the periodic settlement percentages, the periodic settlement payout being payable to the insured in exchange for assignment of the periodic settlement percentage.

The periodic settlement payout goals, the periodic market values, the periodic settlement percentages, and the periodic settlement payouts may be determined in a year-to-year timeframe. The economic circumstances may include tax requirements. The tax requirements may correspond to an estate tax shelter of the insured. The tax requirements may correspond to income tax requirements of the insured. The periodic settlement payout may be less than or equal to the respective periodic settlement payout goal.

Similar to the life settlement method described above, as an aspect of the life settlement policy acquisition method, the insured may assign the periodic settlement percentages to at least one contracting entity in exchange for the periodic settlement payouts. The life insurance policy may require payment of an insurance premium, the insurance premium being divisible into a settlement premium and a remainder premium, the settlement premium being representative of the proportion of the insurance premium corresponding to the periodic settlement percentages, the remainder premium being representative of the proportion of the insurance premium corresponding to the percentage of the life insurance policy not assigned by the insured to the contracting entity.

The method may further include the step of calculating a reacquisition cost in response to a given periodic settlement percentage and a given periodic policy market value, the reacquisition cost being representative of an amount payable by the insured to reacquire the given periodic settlement percentage assignable by the insured.

### BRIEF DESCRIPTION OF THE DRAWINGS

An illustrative and presently preferred embodiment of the invention is shown in the accompanying drawings in which:

FIG. 1 is a block diagram illustrating a life settlement program in accordance with an aspect of the present invention;

FIG. 2 is a block diagram illustrating a settlement payout and a reacquisition cost determinable utilizing economic circumstances, a settlement payout goal, a settlement payout, a settlement percentage, and a policy market value;

FIG. 3a is a diagram illustrating exemplary components of the economic circumstances of an insured;

FIG. 3b illustrates the divisibility of an insurance premium, as it may correlate to settlement of the policy, or a portion thereof.

FIG. 4 is a block diagram illustrating a periodic settlement payout and the reacquisition cost determinable utilizing economic circumstances, a periodic settlement payout goal, a periodic settlement payout, a periodic settlement percentage, and a periodic policy market value; and

FIG. 5 is a table illustrating the relationship of the periodic settlement payout goal, the periodic settlement payout, a periodic settlement percentage, the periodic settlement percentage, and the periodic policy market value a life settlement policy acquisition.

### DETAILED DESCRIPTION OF THE INVENTION

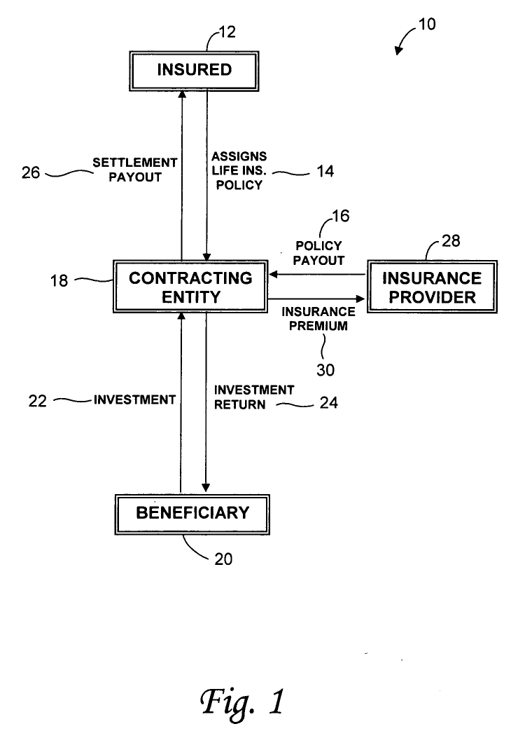

Referring now to the drawings wherein the showings are for purposes of illustrating the preferred embodiment of the present invention only and not for purposes of limiting the same, FIG. 1 is a block diagram illustrating a life settlement program 10 in accordance with an aspect of the present invention. The life settlement program 10 may include an insured 12 possessing a life insurance policy 14 with a settlement payout 26 and a contracting entity 18 for contracting with the insured 12 for assignment of at least a portion of the life insurance policy 14 to a beneficiary 20 designated to receive the net policy payout 16 of the insured 12. It is contemplated that the beneficiary 20 may be an investor. The beneficiary 20 may provide an investment 22 to the contracting entity 18 which may later yield an investment return 24 to the beneficiary 20. Thus the contracting entity 18 may utilize the investment 22 to provide a settlement payout 26 to the insured 12 in exchange for assignment of at least a portion of the insurance policy 14.

Although it is contemplated that an embodiment of the present invention is utilized in conjunction with the sale and distribution of life insurance policies, it is also contemplated that another embodiment of the present invention may be utilized in conjunction with the sale and distribution of other funds with a long term purpose. For example, instead of using the life insurance policy 14, embodiments of the present invention may utilize pension funds, endowment funds, and the like. Therefore, the same principles and teachings that are provided herein regarding life insurance policies are exemplary and may be utilized in conjunction with other funds as desired.

It is also contemplated that the contracting entity 18 may utilize outside vendors to provide services associated with the maintenance of the life insurance policy 14. For example, the contracting entity 18 may utilize a trustee or escrow agent to handle the funds, manage the life insurance policy 14, or perform other functions as desired by the contracting entity 18. Indeed, as will be recognized by those skilled in the field, a system level implementation of the life settlement program 10 may be modified by rearrangement or redistribution of component features or elements of the life settlement program 10. Moreover, the individual component elements may be modified by substitution of equivalent components intended to provide the same or equivalent results. Accordingly, the described life settlement program 10 is not intended to be limiting of the broad aspects of the present invention.

In accordance with one implementation of the present invention, the insured 12 does not have to sell and assign more of the life insurance policy 14 than he wants to. In theory, the insured 12 may continuously update the value of the insurance policy 14 over time in response to various factors known to the insured 12. The insured 12 may carefully regard factors such as health, age, other personal conditions of the insured, market conditions, genetic factors, lifestyle factors, interest rates, to name a few, in order to effectively estimate the amount of money (the settlement payout 26) the insured 12 may receive in exchange for assignment of a portion of the life insurance policy 14. In response to changes in the above-mentioned factors, the insured 12 may desire to sell a certain percentage of his life insurance policy 14. This flexibility allows the insured 12 to treat his life insurance policy 14 as a liquid asset that fluctuates in value. In essence, at the moment when the insured 12 perceives that sale of the life insurance policy 14 would be most profitable, the insured 12 may assign and sell any portion of the life insurance policy 14 as desired.

An implementation of the present invention may also allow the insured 12 to perform intervivos distributions of proceeds from his life insurance policy 14. For example, the insured 12 may desire to leave more for a certain beneficiary than would otherwise be provided under an intestate or testate share for that certain beneficiary. This distribution may be made under one implementation of the present invention.

Additionally, as shown in FIG. 1, an insurance provider 28 may receive an insurance premium 30 paid by the contracting entity 18 for maintenance of the life insurance policy 14 and may later provide the policy payout 16 to the contracting entity 18 upon death of the insured 12. It is contemplated that after the assignment, the insured 12 may not be required to continue paying the insurance premium 30 of the life insurance policy 14. However, in one implementation of the invention, it is also contemplated that upon assignment of only a portion of the life insurance policy 14, the insured 12 may be required to continue paying at least a portion of the insurance premium 30.

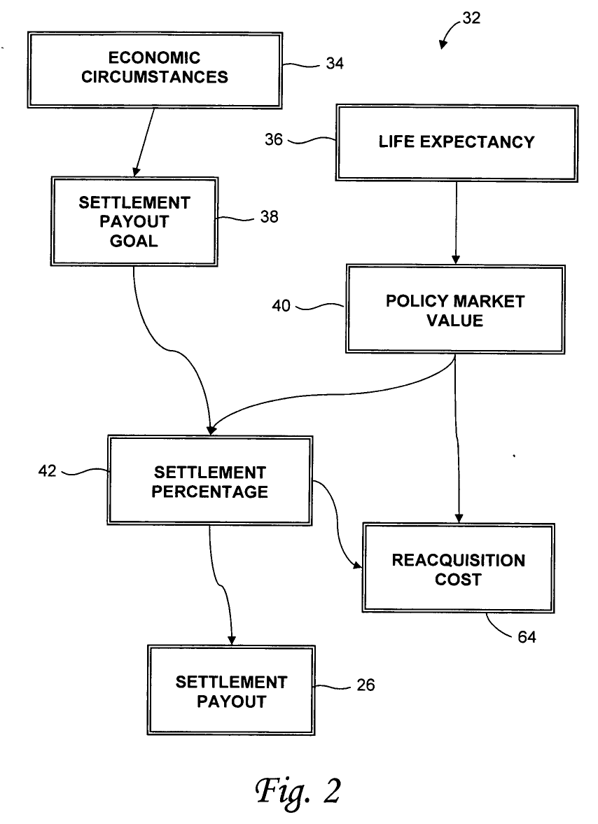

According to an aspect of the present invention, a life settlement method 32 is provided for fractionalizing the life insurance policy 14 in response to economical circumstances 34 of the insured 12. Referring to FIG. 2, the insured 12 may have a life expectancy 36. It is contemplated that the life expectancy 36 of the insured 12 may be calculated in a variety of ways, as described in co-pending application entitled “LIFE SETTLEMENT BUSINESS METHOD AND PROGRAM BASED ON ACTUARIAL/EXPECTANCY DATA,” for Weiss et al. (Ser. No. to be determined), the contents of which are incorporated herein by reference. Thus, the life expectancy 36 may be calculated utilizing medical information of the insured 12 as well as other actuarial information, e.g. genetic and lifestyle factors. In this regard, the new “life tables” may be formulated for the technical assessment of the life expectancy 36. Such “life tables” may be distinct from standard actuarial tables such as the Standard Mortality Tables of 1959.

The life settlement method 32 may include the steps of determining a settlement payout goal 38 in response to the economic circumstances 34 of the insured 12; determining a policy market value 40 of the life insurance policy 14 in response to the life expectancy 36 of the insured 12; calculating a settlement percentage 42 in response to the settlement payout goal 38 and the policy market value 40, the settlement percentage 42 being representative of a percentage of the life insurance policy 14 being assignable by the insured 12; and calculating the settlement payout 26 in response to the settlement percentage 42, the settlement payout 26 being payable to the insured 12 in exchange for assignment of the settlement percentage 42.

In accordance with an implementation of the present invention, the contracting entity 18 may also benefit from the fractionalization of the life insurance policy 14. A contracting entity 18 may purchase several individual portions (the settlement percentage 42) of the life insurance policies 14 of numerous insureds 12. These settlement percentages 42 may be organized into investment funds according to risk, longevity, size, and other characteristics. An illustrative example may be the acquisition of one thousand (1000) individual settlement percentages 42. These 1000 settlement percentages 42 may be divided into groups according to risk, such as a high-risk, medium-risk, and low-risk.

For example, settlement percentages 42 in the high-risk category may be those settlement percentages 42 acquired from insureds 12 with life expectancies 36 of less than one year. In such a case, the investment fund may be set up to provide a higher investment return 24 to the investors. However, if the insureds 12 outlive the life expectancies 36, the settlement percentages 42 will not be liquidated as planned, upon completion of the one year period, and the investment return 24 may be low or negative.

In the alternative, a low-risk fund may be organized that may provide a more modest return based upon conservative projections regarding the life expectancies 36 corresponding to the settlement percentages 42 included in the fund. It is contemplated that various classes of investment funds may be created and organized in response to factors through which the settlement percentages 42 are both unique and similar. Such factors may include those considered in evaluating the life expectancies 36 of each individual insured 12, as known in life expectancy tables and standard actuarial tables such as the Standard Mortality Tables of 1959, and other factors described in detail in co-pending application entitled “LIFE SETTLEMENT BUSINESS METHOD AND PROGRAM BASED ON ACTUARIAL/EXPECTANCY DATA,” for Weiss et al. (Ser. No. to be determined), the contents of which are incorporated herein by reference.

As shown in FIG. 2, according to an aspect of the present invention, the settlement payout goal 38 may be determined by the insured 12 in response to the economic circumstances 34 of the insured 12. It is contemplated that the settlement payout goal 38 may be determined by the contracting entity 18 or other professionals skilled in the art.

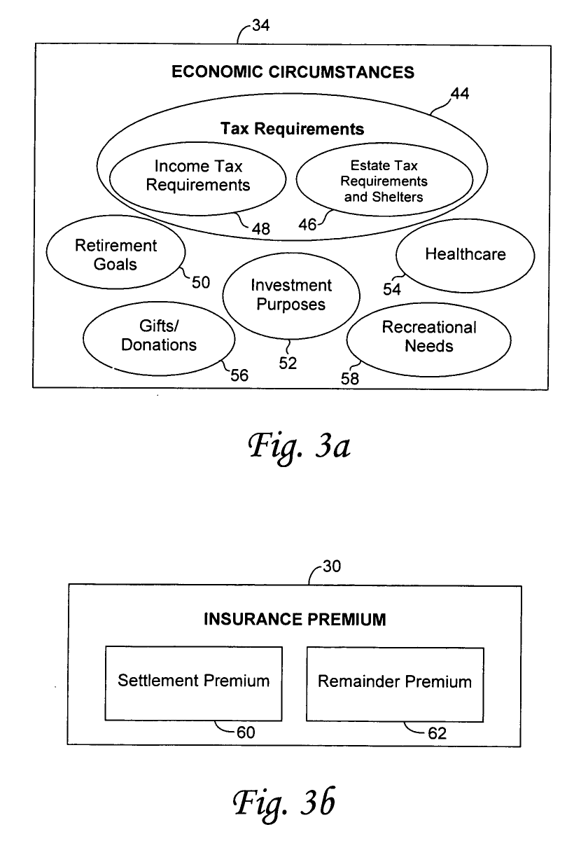

Referring now to FIG. 3a, the economic circumstances 34 may include tax requirements 44. The tax requirements 44 may correspond to estate tax requirements and shelters 46. The tax requirements 44 may also correspond to income tax requirements 48 of the insured 12. According to another aspect of the present invention, the economic circumstances 34 may also include retirement goals 50, investment purposes 52, healthcare 54, gifts/donations 56, recreational needs 58, or other important economic considerations, as also shown in FIG. 3. However, the factors illustrated in FIG. 3 are for exemplary purposes only and are not intended to limit the circumstances which the insured 12 may evaluate in determining the settlement payout goal 38. Indeed, the economic circumstances 34 may broadly include any reason for which the insured 12 seeks to access money available through assignment of his life insurance policy 14.

For example, an insured 12 may require $5000.00 per month during his retirement in response to retirement goals 50 and as such, this figure would constitute the settlement payout goal 38. In another example, the insured 12 may seek to distribute settlement proceeds of his life insurance policy 14 more quickly. In such a case, as illustrated in FIG. 3a, the insured 12 may face certain income tax or estate tax limitations. Therefore, the settlement payout goal 38 may correspond to these estate tax requirements and the availability of shelters 46 and income tax requirements 48. In one implementation, where the insured 12 has predefined limits to his income or intervivos distributions of his estate, these limits may represent the settlement payout goal 38. Thus the settlement payout 26 may correspond thereto and be less than or equal to the settlement payout goal 38 in order to comply with the aforementioned predefined limits. In this manner, an insured 12 may be enabled to distribute the proceeds of his life insurance policy 14 in a systematic manner which allows the insured 12 to take advantage of certain estate tax requirements and shelters 46 or income tax requirements 48. Thus the insured 12 may not be required to pay exorbitant estate taxes or income taxes due to one large lump sum settlement payout 26.

Therefore, according to an aspect of the present invention, the insured 12 may therefore fractionalize his life insurance policy 14 to assign only a percentage of the life insurance policy 14 in exchange for a smaller amount of proceeds from the life insurance policy 14. Thus the insured 12 may assign a percentage of the life insurance policy 14 to the contracting entity 18 in exchange for the settlement payout 26 which is typically proportional to the settlement percentage 42.

In accordance with an implementation of the present invention, the owner of a fractionalized interest of the life insurance policy 14, whether the owner is the insured 12 or the contracting entity 18, may protect its fractionalized interest in the event that the fractionalized interest is threatened. It is contemplated that in some circumstances fees, premiums, and/or unexpected events may arise that threaten lapse of the life insurance policy 14. In response to such circumstances, the owner of the fractionalized interest may pledge or borrow against the fractionalized interest or otherwise utilize the fractional interest to protect against such economic perils. For example, in the event that the insurance premium 30 may not be paid when due, the owner may borrow against the fractionalized interest to obtain the finds necessary to pay the insurance premium 30 in order to avoid lapse of the life insurance policy 14.

In accordance with another aspect of the present invention, it is contemplated that the contracting entity 18 may offer a “guarantee program” to the beneficiary 20. As an aspect of the “guarantee program,” the contracting entity 18 provides the beneficiary 20 with a designated date whereon the beneficiary 20 will receive the investment return 24. Further, the contracting entity 18 may offer other incentives to the beneficiary 20 in order to mitigate risks associated with investing in life settlement. The contracting entity 18 may also provide a “contestable period guarantee” to the beneficiary 20. As an aspect of the “contestable period guarantee,” the contracting entity 18 may protect the beneficiary 20 against actions taken by the insurance provider 28 that result in losses during the contestable period of the insurance policy 14.

Referring again to FIG. 2, according to another aspect of the present invention, the policy market value 40 of the life insurance policy 14 may be determined in response to the life expectancy 36 of the insured 12. It is contemplated that the life expectancy 36 of the insured 12 may be calculated in a variety of ways, as described in co-pending application entitled “LIFE SETTLEMENT BUSINESS METHOD AND PROGRAM BASED ON ACTUARIAL/EXPECTANCY DATA,” for Weiss et al. (Ser. No. to be determined), the content of which is incorporated herein by reference. Such calculations may include evaluating the medical data of the insured 12, the actuarial data of the insured 12, and combinations thereof. It is contemplated that the policy market value 40 of the life insurance policy 14 may be determined at the time in which the insured 12 seeks to assign a percentage of his life insurance policy 14. It is also contemplated that the policy market value 40 may be calculated for present or future times by considering various economic indicators such as market indicators and the like.

As illustrated in FIG. 2, according to yet another aspect of the present invention, the settlement percentage 42 may be calculated in response to the settlement payout goal 38 and the policy market value 40. In one embodiment of the present invention, the settlement percentage 42 may be representative of a percentage of the life insurance policy 14. In some cases, the settlement percentage 42 may be a small percentage, for example 10% or less, of the overall insurance policy; however, in other cases the desired settlement percentage 42 may include the majority of the overall life insurance policy 14, such as 75% or more. As such, the settlement percentage 42 may include any percentage of the life insurance policy 14.

As shown in FIG. 2, in accordance with an embodiment of the present invention, the settlement payout 26 may be calculated in response to the settlement percentage 42. The settlement payout 26 may be representative of the monetary value of the settlement percentage 42. In one embodiment of the invention, the settlement payout 26 may be provided to the insured 12 in one lump sum payment. It is contemplated that the settlement payout 26 may be provided to the insured 12 as interest on an investment 22. In another embodiment, the settlement payout 26 may be provided in a series of payments, for which interest or other benefits may be provided to the insured 12. Deferred payments, or a series of payments, may require assignment of a smaller percentage of his life insurance policy 14.

As described in connection with FIG. 2, the settlement payout 26 may be calculated and manipulated utilizing the settlement percentage 42, the settlement payout goal 38 and the policy market value 40. Thus the settlement payout 26 may be indirectly determined by the policy market value 40 and the settlement payout goal 38. It is contemplated that the contracting entity 18 and the insured 12 may selectively manipulate the settlement payout goal 38 and utilize past, present, or future policy market values in order to provide the insured 12 with various options relating to the settlement percentage 42 and the settlement payout 26. In such a case, the contracting entity 18 may therefore provide the insured 12 with greater flexibility in assigning the life insurance policy 14 and receiving the settlement payout 26.

Referring now to FIG. 3b, in an embodiment of the present invention, the insurance premium 30 may be divisible into a settlement premium 60 and a remainder premium 62. The settlement premium 60 may be representative of the proportion of the insurance premium 30 corresponding to the settlement percentage 42. The remainder premium 62 may be representative of the proportion of the insurance premium 30 corresponding to the percentage of the life insurance policy 14 not assigned by the insured 12 to the contracting entity 18. Thus, it is contemplated that the settlement premium 60 and the remainder premium 62 may be cumulatively equal to the insurance premium 30, at least in concept.

It is contemplated that the contracting entity 18 may pay the settlement premium 60 and the insured 12 may pay the remainder premium 62. Such payment may be remitted directly to an insurance provided, as shown in FIG. 1. However, it is also contemplated that the contracting entity 18 may require the insured 12 to pay the contracting entity 18 the remainder premium 62 in order for the contracting entity 18 to adequately protect its interest in the settlement percentage 42 assigned to the contracting entity 18. It is alternatively contemplated that the contracting entity 18 may contract with the insured 12 to pay the entire settlement premium 60 for the insured 12 in exchange for a larger portion of the settlement payout 26, or assignment of an additional percentage of the life insurance policy 14.

In another embodiment of the present invention, referring again to FIG. 2, the life settlement method 32 may further include the step of calculating a reacquisition cost 64 in response to the settlement percentage 42 and the policy market value 40. In theory, this procedure may be necessary for the insured 12 when the insured 12 seeks to recover or reacquire the settlement percentage 42 assigned to the contracting entity 18. The reacquisition cost 64 may be representative of an amount payable by the insured 12 to reacquire the settlement percentage 42 assignable by the insured 12. Thus, after the insured 12 has assigned the settlement percentage 42 to the contracting entity 18, the insured 12 may seek to reacquire the settlement percentage 42. In concept, the reacquisition cost 64 may likely be greater than the settlement payout 26 in order to compensate the contracting entity 18 for reasonable interest on the settlement percentage 42. The reacquisition cost 64 may then be the amount payable by the insured 12 to the contracting entity 18 in order for the contracting entity 18 to assign the settlement percentage 42 to the insured 12. Through payment of the reacquisition cost 64, ownership of the settlement percentage 42 may be restored to the insured 12.

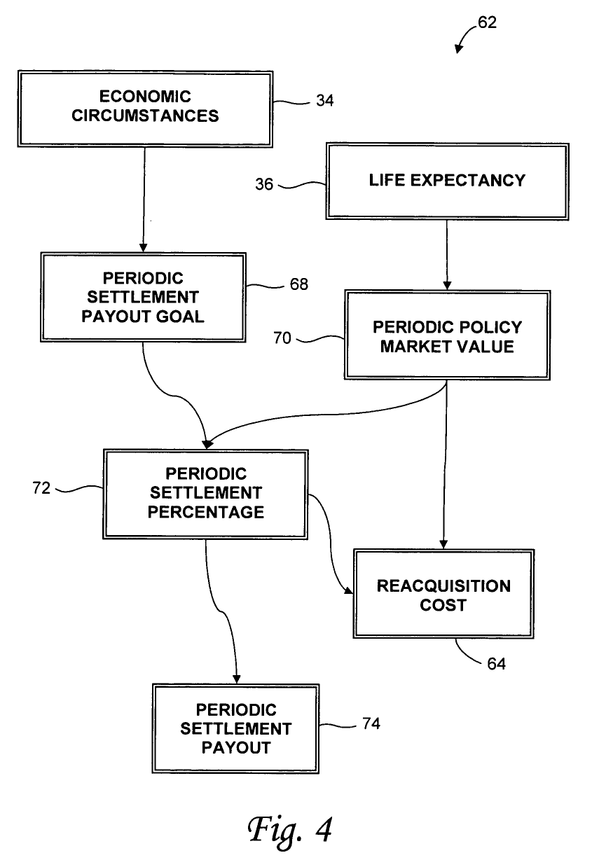

In another embodiment of the present invention, as shown in FIG. 4, a life settlement policy acquisition method 66 for fractionalizing an entire life insurance policy 14 in response to economic circumstances 34 of an insured 12 is provided. The insured 12 may have a life expectancy 36. The life settlement policy acquisition method 66 may include the steps of determining periodic settlement payout goals 68 in response to the economic circumstances 34 of the insured 12; determining periodic market values of the life insurance policy 14 in response to the life expectancy 36 of the insured 12; calculating periodic settlement percentages 72 in response to the periodic settlement payout goals 68 and the periodic policy market values 70, the periodic settlement percentage 72 being representative of a percentage of the life insurance policy 14 being assignable by the insured 12; and calculating periodic settlement payouts 74 in response to the periodic settlement percentages 72, the periodic settlement payout 74 being payable to the insured 12 in exchange for assignment of a generally corresponding periodic settlement percentage 72.

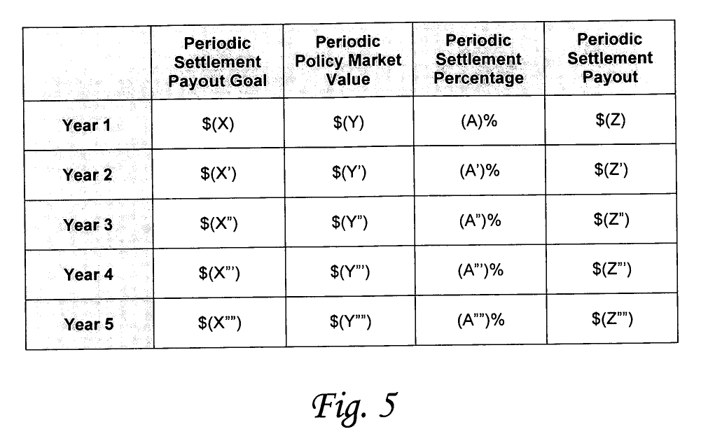

In accordance with an embodiment of the present invention, it is contemplated that the life settlement policy acquisition method 66 may allow an insured 12 to fractionalize and assign his entire life insurance policy 14. Such fractionalization and assignment of the entire life insurance policy 14 may be accomplished pursuant to a schedule or plan. For example, as shown in FIG. 5, an insured 12 may seek to receive the periodic settlement payout 74 on a yearly basis. Nevertheless, it is also contemplated that the periodic settlement payout 74 may be received by the insured 12 on a monthly, weekly or other periodic basis.

According to another aspect of the present invention, as shown in FIG. 4, the periodic settlement payout goals 68 may be determined in response to the economic circumstances 34 of the insured 12. It is contemplated that the settlement payout goal 38 may be determined by the contracting entity 18 or other professional skilled in the art. As shown in FIG. 3, the economic circumstances 34 may include the tax requirements 44. It is contemplated that the tax requirements 44 may correspond to the estate tax requirements and shelters 46 of the insured 12. Additionally, it is contemplated that the tax requirements 44 may correspond to income tax requirements 48 of the insured 12. It is contemplated that the periodic settlement payout 74 may be less than or equal to the respective periodic settlement payout goal 68. For example, it may be advantageous to the insured 12 to receive no more than a certain amount due to the income tax requirements 48 of the insured 12. In such a case, the periodic settlement payout goals 68 may correspond to the yearly limitations reflective of the income tax requirements 48 or estate tax requirements and shelters 46 of the insured 12. Thus in situations where the life insurance policy 14 is for a large amount (particularly those over an amount of $5,000,000.00), the insured 12 may contract to assign the periodic settlement percentage 72 to the contracting entity 18 in exchange for the periodic settlement payout 74 optimized with respect to the insured's 12 income or estate tax requirements and available of shelters 46.

In addition, according to another aspect of the present invention, the economic circumstances 34 may also include the retirement goals 50, investment purposes 52, healthcare 54, gifts/donations 56, recreational needs 58, or other important economic considerations, as also shown in FIG. 3. However, the factors illustrated in FIG. 3 are for exemplary purposes only and are not intended to limit the circumstances which the insured 12 may evaluate in determining the periodic settlement payout goal 68. Indeed, the economic circumstances 34 may broadly include any reason for which the insured 12 seeks to access money available through assignment of his life insurance policy 14.

Referring again to FIG. 4, according to another aspect of the present invention, the periodic policy market values 70 of the life insurance policy 14 may be determined in response to the life expectancy 36 of the insured 12. The life expectancy 36 of the insured 12 may be calculated in a variety of ways. Such calculations may include the medical data of the insured 12, the actuarial data of the insured 12, and combinations thereof. It is contemplated that the periodic policy market values 70 of the life insurance policy 14 may be determined at the times in which the insured 12 seeks to assign a percentage of his life insurance policy 14. It is also contemplated that the periodic policy market values 70 may be calculated for present or future times by considering other various economic indicators such as market indicators and the like.

As illustrated in FIG. 4, according to yet another aspect of the present invention, the periodic settlement percentages 72 may be calculated in response to the periodic settlement payout goals 68 and the periodic policy market values 70. In one embodiment of the present invention, the periodic settlement percentage 72 may be representative of a percentage of the life insurance policy 14. It is contemplated that the periodic settlement percentage 72 may be a small percentage, for example 10% or less, of the overall insurance policy; however, it is also contemplated that the periodic settlement percentage 72 may include the majority of the overall life insurance policy 14, such as 75% or more. Nevertheless, the periodic settlement percentage 72 may include any percentage of the life insurance policy 14.

In an embodiment of the present invention, the periodic settlement percentages 72 cumulatively equal 100% of the overall insurance policy such that the insured 12 assigns the entirety of the life insurance policy 14 to the contracting entity 18 over time on a periodic basis. As mentioned above, it is contemplated that the periodic basis may be yearly. Thus, according to one embodiment of the present invention, the contracting entity 18 and the insured 12 may develop a plan wherethrough the insured 12 may make yearly assignments to the contracting entity 18 of the periodic settlement percentage 72 in exchange for the periodic settlement payout 74. Thus, over several years, the insured 12 will have assigned the entire insurance policy to the contracting entity 18. This scenario is suggestively illustrated in FIG. 5. However, the periodic basis may be monthly, biannually, or other periodic intervals. Additionally, the periodic basis may be changed according to the personal preference of the insured 12 in order to best meet the insured's economic circumstances 34.

As shown in FIG. 4, in accordance with an embodiment of the present invention, the periodic settlement payout 74 may be calculated in response to the periodic settlement percentage 72. The periodic settlement payout 74 may be representative of the monetary value of the respective periodic settlement percentage 72. For example, referring to FIG. 5, the periodic settlement payout 74 of Year 1 may be calculated in response to the periodic settlement percentage 72 of Year 1. The periodic settlement percentage 72 of Year 1 may be calculated in response to the periodic settlement payout goal 68 of Year 1 and the periodic policy market value 70 of Year 1. Likewise, the calculation will be repeated for Year 2, Year 3, etc., or any other periodic basis:

Similar to the life settlement method described above, as an aspect of the life settlement policy acquisition method, the periodic settlement payout 74 may be provided to the insured 12 in one lump sum payment. The periodic settlement payout 74 may be provided to the insured 12 through credit, check, cash, or other forms of consideration. It is contemplated that the periodic settlement payout 74 may be provided to the insured 12 as an interest in an investment 22. It is also contemplated that the periodic settlement payout 74 may be provided in a series of payments, for which interest or other benefits may be provided to the insured 12. For example, referring to FIG. 5, it is also contemplated that the periodic settlement payout 74 of Year 1 may be divided and provided to the insured 12 on a monthly basis instead of a lump sum payment. Thus in exchange for a deferred payment, or a series of payments, the insured 12 may assign a smaller percentage of his life insurance policy 14.

As illustrated in FIG. 4, the periodic settlement payout 74 may be calculated and manipulated utilizing the periodic settlement percentage 72, the periodic settlement payout goal 68 and the periodic policy market value 70. Thus the periodic settlement payout 74 may be indirectly determined by the periodic policy market value 70 and the periodic settlement payout goal 68. The contracting entity 18 and the insured 12 may selectively manipulate the periodic settlement payout goal 68 and utilize past, present, or future periodic policy market values 70 in order to provide the insured 12 with various options relating to the periodic settlement percentage 72 and the periodic settlement payout 74. In such a case, the contracting entity 18 may therefore provide the insured 12 with greater flexibility in assigning the life insurance policy 14 and receiving the periodic settlement payout 74.

Referring now to FIG. 3b, and as previously similarly described with regard to the life settlement method above, in an embodiment of the present invention with regard to the life settlement policy acquisition method, the insurance premium 30 may be divisible into a settlement premium 60 and a remainder premium 62. The settlement premium 60 may be representative of the proportion of the insurance premium 30 corresponding to the periodic settlement percentage 72. The settlement premium 60 may representative of that proportion of the insurance premium 30 corresponding to the overall percentage of the insurance policy that has been assigned by the insured 12 to the contracting entity 18. The remainder premium 62 may be representative of the proportion of the insurance premium 30 corresponding to the percentage of the life insurance policy 14 not assigned by the insured 12 to the contracting entity 18. Thus it is contemplated, that the settlement premium 60 and the remainder premium 62 may be cumulatively equal to the insurance premium 30.

As previously described with regard to the life settlement method above, it is also contemplate that as an aspect of the life settlement policy acquisition method, the contracting entity 18 may pay the settlement premium 60 and the insured 12 may pay the remainder premium 62. Such payment may be remitted directly to an insurance provider 28. However, it is also contemplated that the contracting entity 18 may require the insured 12 to pay the contracting entity 18 the remainder premium 62 in order for the contracting entity 18 to adequately protect its interest in the settlement percentage 42 assigned to the contracting entity 18. It is contemplated that the contracting entity 18 may also contract with the insured 12 to pay the settlement premium 60 for the insured 12 in exchange for a portion of the settlement payout 26 or assignment of an additional percentage of the life insurance policy 14.

In another embodiment of the present invention, referring again to FIG. 4, the life settlement policy acquisition method 66 may further include the step of calculating a reacquisition cost 64 in response to the periodic settlement percentage 72 and the policy market value 40. The reacquisition cost 64 may be representative of an amount payable by the insured 12 to reacquire the periodic settlement percentage 72 assignable by the insured 12. It is contemplated that after the insured 12 has assigned the periodic settlement percentage 72 to the contracting entity 18, the insured 12 may seek to reacquire the periodic settlement percentage 72. In such a case, the reacquisition cost 64 may be that amount payable by the insured 12 to the contracting entity 18 in order for the contracting entity 18 to assign the periodic settlement percentage 72 to the insured 12. Thus it is contemplated that the reacquisition of the periodic settlement percentage 72 may restore the periodic settlement percentage 72 to the ownership of the insured 12.

This description of the various embodiments of the present invention is presented to illustrate the preferred embodiments of the present invention, and other inventive concepts may be otherwise variously embodied and employed. The appended claims are intended to be construed to include such variations except insofar as limited by the prior art.

What is claimed is:

1. A life settlement method for fractionalizing a life insurance policy in response to economic circumstances of an insured having a life expectancy, the method comprising:
a. determining a settlement payout goal in response to the economic circumstances of the insured;
b. determining a policy market value of the life insurance policy in response to the life expectancy of the insured;
c. calculating a settlement percentage in response to the settlement payout goal and the policy market value, the settlement percentage being representative of a percentage of the life insurance policy; and
d. calculating a settlement payout in response to the settlement percentage, the settlement payout being payable to the insured in exchange for assignment of the settlement percentage.

2. The method of claim 1 wherein the economic circumstances include tax requirements.

3. The method of claim 2 wherein the tax requirements correspond to an estate tax shelter of the insured.

4. The method of claim 2 wherein the tax requirements correspond to income tax requirements of the insured.

5. The method of claim 2 wherein the settlement payout is less than or equal to the settlement payout goal.

6. The method of claim 1 wherein the insured assigns the settlement percentage to a contracting entity in exchange for the settlement payout.

7. The method of claim 6 wherein the life insurance policy requires payment of an insurance premium, the insurance premium being divisible into a settlement premium and a remainder premium, the settlement premium being representative of the proportion of the insurance premium corresponding to the settlement percentage, the remainder premium being representative of the proportion of the insurance premium corresponding to the percentage of the life insurance policy not assigned by the insured to the contracting entity.

8. The method of claim 1 further comprising the step of calculating a reacquisition cost in response to the settlement percentage and the policy market value, the reacquisition cost being representative of an amount payable by the insured to reacquire the settlement percentage assignable by the insured.

9. A life settlement policy acquisition method for fractionalizing an entire life insurance policy in response to economic circumstances of an insured having a life expectancy, the method comprising:
a. determining periodic settlement payout goals in response to the economic circumstances of the insured;
b. determining periodic policy market values of the life insurance policy in response to the life expectancy of the insured;
c. calculating periodic settlement percentages in response to the periodic settlement payout goals and the periodic policy market values, the periodic settlement percentage being representative of a percentage of the life insurance policy; and
d. calculating periodic settlement payouts in response to the periodic settlement percentages, the periodic settlement payout being payable to the insured in exchange for assignment of the periodic settlement percentage.

10. The method of claim 9 wherein the periodic settlement payout goals, the periodic market values, the periodic settlement percentages, and the periodic settlement payouts are determined in a year-to-year timeframe.

11. The method of claim 9 wherein the economic circumstances include tax requirements.

12. The method of claim 11 wherein the tax requirements correspond to an estate tax shelter of the insured.

13. The method of claim 11 wherein the tax requirements correspond to income tax requirements of the insured.

14. The method of claim 11 wherein the periodic settlement payout is less than or equal to the respective periodic settlement payout goal.

15. The method of claim 9 wherein the insured assigns the periodic settlement percentages to at least one contracting entity in exchange for the periodic settlement payouts.

16. The method of claim 15 wherein the life insurance policy requires payment of an insurance premium, the insurance premium being divisible into a settlement premium and a remainder premium, the settlement premium being representative of the proportion of the insurance premium corresponding to the periodic settlement percentages, the remainder premium being representative of the proportion of the insurance premium corresponding to the percentage of the life insurance policy not assigned by the insured to the contracting entity.

17. The method of claim 9 further comprising the step of calculating a reacquisition cost in response to a given periodic settlement percentage and a given periodic policy market value, the reacquisition cost being representative of an amount payable by the insured to reacquire the given periodic settlement percentage assignable by the insured.
